(19) United States
(12) Patent Application Publication
(10) Pub. No.: US 2013/0128570 A1
(43) Pub. Date: May 23, 2013

(54) SECONDARY OPTICAL APPARATUS FOR A CIRCULAR LED ARRAY

(71) Applicants: Jin Bo JIANG, Hong Kong (HK); Wen Da Jiang, Hong Kong (HK)

(72) Inventors: Jin Bo JIANG, Hong Kong (HK); Wen Da Jiang, Hong Kong (HK)

(21) Appl. No.: 13/298,839

(22) Filed: Nov. 17, 2011

(51) Int. Cl. F21V 7/04; F21V 7/00

(52) U.S. Cl. 362/235

(57) ABSTRACT

A secondary optical apparatus for a circular light emitting diode (LED) array includes a plurality of LEDs circularly disposed on a plane; and a reflector having an annular reflecting surface oriented above the LEDs such that one portion of the light emitting from the LEDs is reflected by the annular reflecting surface sideward and backward to form a radially outwardly diverging beam having light distribution above and below the plane, and another portion of the light emitting from the LEDs is directed forward to form a forwardly-projecting beam.

### FIELD OF THE INVENTION

The present invention relates to a lighting device, and more particularly, relates to a secondary optical apparatus for a circular light emitting diode (LED) array.

### BACKGROUND OF THE INVENTION

Conventional tungsten lamp has a wide angular distribution. The light emitted from such lamp almost fills all of the space therearound. Except that a portion of the light projects forward ,and that another portion of the light projects backward, and that another portion of the light is sheltered by the lamp holder, the light distribution angle of such lamp may reach about 270° to 360°. However, the high power LED projects all light forward, which makes a field angle of about 120°.In certain applications, it is necessary to have light projecting backward besides light projecting forward, which requires the light source has a light distribution with a very large azimuth. The crystal droplight for indoor illumination requires a light source with a large spatial distribution angle, which is required to meet the needs of side and back illumination besides forward illumination, in order to illuminate almost all crystal sling flakes. The object of present invention is to provide an optical apparatus, which may distribute the light from the LED in an ultra large azimuth ranging in 270°˜360° Besides energy saving, it may replace the conventional tungsten bulb in optical characteristics.

### SUMMARY OF THE INVENTION

According to one aspect of the present invention, there is provided a secondary optical apparatus for a circular light emitting diode array. The apparatus comprises a plurality of light emitting diodes (LEDs) circularly disposed on a plane; and a reflector having an annular reflecting surface oriented above the LEDs such that one portion of the light emitting from the LEDs is reflected by the annular reflecting surface sideward and backward to form a radially outwardly diverging beam having light distribution above and below the plane, and another portion of the light emitting from the LEDs is directed forward to form a forwardly-projecting beam.

According to one embodiment, the reflector comprises a flared reflecting surface; and a plurality of apertures extending through and arranged circumferentially around the reflector; whereby a first portion of the light emitting from the LEDs is reflected by the flared reflecting surface to form the radially outwardly diverging beam, and a second portion of the light emitting from the LEDs passes through the apertures and forms the forwardly-projecting beam. The radially outwardly diverging beam has an illumination angle of about 30° to about 50° above the plane and an illumination angle of about 45° to about 75° below the plane, and the forwardly-projecting beam has a field angle of about 90° to about 150°.

According to another embodiment, the reflector comprises first and second flared reflecting surfaces; and a plurality of apertures extending through and arranged circumferentially around the reflector; whereby a first portion of the light emitting from the LEDs is reflected by the first flared reflecting surface to form a first radially outwardly diverging beam above the plane, a second portion of the light emitting from the LEDs is reflected from the second flared reflecting surface to form a second radially outwardly diverging beam below the plane, and a third portion of the light emitting from the LEDs passes through the apertures and forms the forwardly-projecting beam. The first radially outwardly diverging beam has an illumination angle of about 30° to about 50° above the plane, the second radially outwardly diverging beam has an illumination angle of about 45° to about 75° below the plane, and the forwardly-projecting beam has a field angle of about 90° to about 150°.

The secondary optical apparatus may have at least four LEDs. The thickness of the reflector may be about 0.1 mm to about 2.0 mm. Each aperture may be circular and may have a diameter of about 0.5 mm to about 2.0 mm. The distance between two adjacent apertures may be about 0.5 mm to about 2.0 mm.

According to a further embodiment, the reflector is in the form of a lens comprises (a) a lens body; (b) an annular recess formed on a bottom side of the lens body in which the LEDs are located, the annular recess being defined by a middle annular collimation surface, an outer annular side surface and an inner annular side surface; (c) an outer annular total reflection surface formed on a lower portion of the lens body and extending outwardly from the outer annular side surface, and an inner annular total reflection surface formed on the lower portion of the lens body and extending inwardly from the inner annular side surface; (d) a central solid cylindrical portion formed at a top side of the lens body and having an upper light-diverging surface in the shape of a plurality of concentric rings having a sinusoidal cross-section; (e) an inverted frusto-conical total reflection surface extending outwardly from a cylindrical surface of the central solid cylindrical portion; and (f) an annular light-diverging surface having a sinusoidal cross-section formed between the inverted frusto-conical total reflection surface and the outer annular total reflection surface. A first portion of the light emitting from the LEDs and passing through the outer annular side surface is reflected upwards by the outer annular total reflection surface and then reflected radially outwardly by the inverted frusto-conical total reflection surface towards the annular light-diverging surface to form a first radially outwardly diverging beam, a second portion of the light emitting from the LEDs and passing through the middle annular collimation surface is collimated and reflected radially outwards by the inverted frusto-conical total reflection surface towards the annular light-diverging surface to form a second radially outwardly diverging beam, a third portion of the light emitting from the LEDs and passing through the middle annular collimation surface is collimated towards the upper light-diverging surface to form a first forwardly-projecting beam, and a fourth portion of the light emitting from the LEDs and passing through the inner annular side surface is reflected by the inner annular total reflection surface upwardly towards the upper light-diverging surface to form a second forwardly-projecting beam.

The first and second radially outwardly diverging beams have an illumination angle of about 90°, and the first and second forwardly-projecting beams have an illumination angle of about 90°. The lens may further include an annular platform formed between the annular light-diverging surface and the outer annular total reflection surface.

The secondary optical apparatus may further include a substantially spherical light-transmittable cover for covering the reflector and the LEDs, whereby the light emitting through the cover has a field angle of about 270° to about 360°.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 is a section view of a secondary optical apparatus according to embodiment 1 of the present invention;

FIG. 2 shows the arrangement of the LED light source of the embodiment 1;

FIG. 3 shows different views of the reflective sheet of the embodiment 1;

FIG. 4 shows the light distribution of the secondary optical apparatus of the embodiment 1;

FIG. 5 shows an application of the embodiment 1 in an LED bulb lamp;

FIG. 6 shows the ray trace of the embodiment 1;

FIG. 7 and FIG. 8 show the far-field angular distribution of the light intensity of the embodiment 1;

FIG. 9 is the ray trace of a LED bulb lamp;

FIG. 10 is the light distribution curve of the LED bulb lamp adopting the embodiment 1;

FIG. 11 is a section view of the secondary optical apparatus according to embodiment 2 of the present invention;

FIG. 12 shows different views of the reflective sheet of the embodiment 2;

FIG. 13 shows the light distribution of the secondary optical apparatus of the embodiment 2;

FIG. 14 and FIG. 15 show the computer simulation of the embodiment 2;

FIG. 16 shows an arrangement of a circular LED light source according to embodiment 3 of the present invention;

FIG. 17 shows a section view of a secondary optical apparatus according to the embodiment 3 of the present invention;

FIG. 18 shows different views of the reflective sheet of the embodiment 3;

FIG. 19 shows the light distribution of the secondary optical apparatus of the embodiment 3;

FIG. 20 shows the ray trace of the embodiment 3;

FIG. 21 shows the far-field angular distribution of the light intensity of the embodiment 3; and

FIG. 22 shows the far-field angular distribution of the light intensity of the embodiment 3 when the size of the chip is 0.2×0.2 mm.

### DETAILED DESCRIPTION OF THE INVENTION

### Embodiment 1

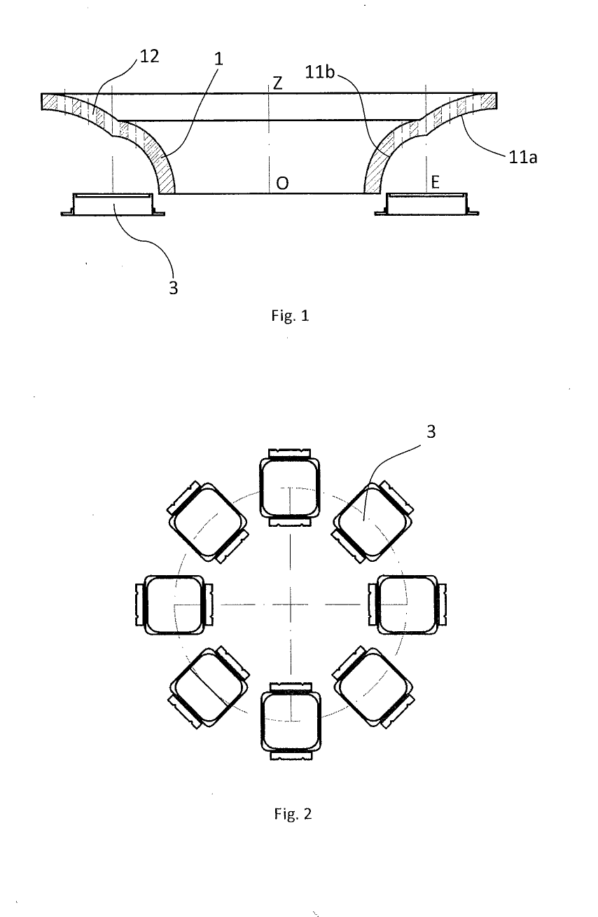

FIG. 1 is a section view of a secondary optical apparatus according to embodiment 1 of the present invention. In this figure, the numeral reference 3 indicates an array of light emitting diodes (LED) arranged in a circle according to the present embodiment, the letter reference E indicates the center of the emission surface of the LED light source array, the numeral reference 1 indicates a reflector or reflective sheet which may include two small flared annular reflecting surfaces 11a and 11b with different radians, the numeral reference 12 indicates apertures or through holes in the reflector, and the letter reference OZ indicates the turning axis of the reflector.

FIG. 2 shows the arrangement of the LED light source of the present embodiment, in which the LEDs 3 may be a LED light source array arranged in a circle by four or more respective patch LEDs or semi-spherically packaged LEDs. In this case, the present embodiment preferably adopts 8 patch MX6 LEDs from CREE® which form a light source in a circle.

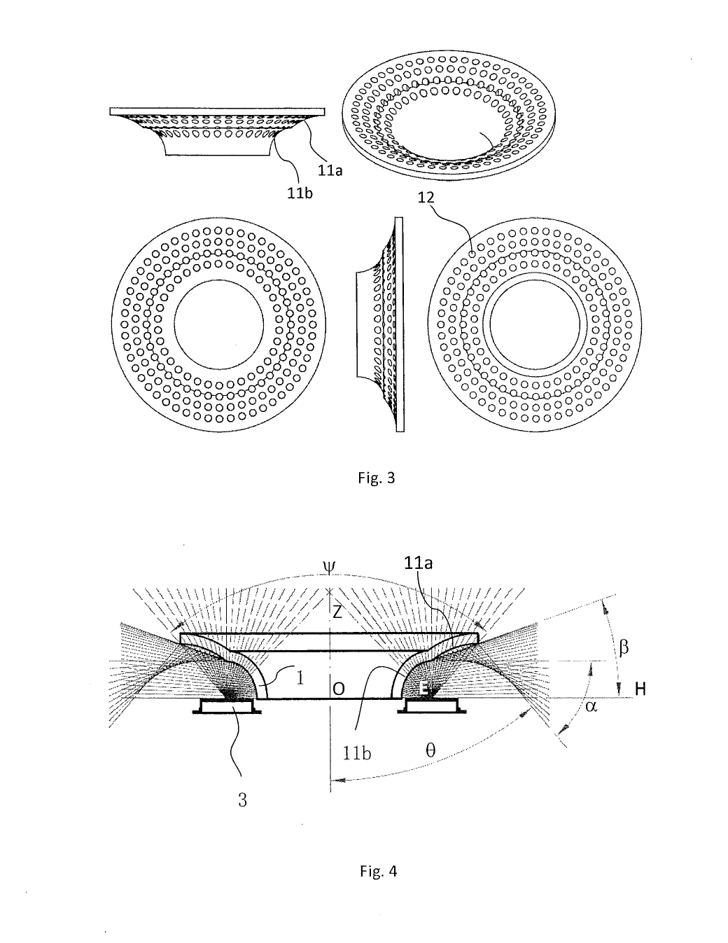

FIG. 3 shows different views of the reflective sheet in the present embodiment. The reflector or reflective sheet 1 may include one or more small flared annular reflecting surfaces, preferably two small flared annular reflecting surfaces 11 a and 11b with different radians. The reflective sheet 1 has many small apertures or through holes 12 therein, which have respective shape of circle or polygon or any other possible shape, preferably circular through holes. The through holes 12 extend through and arrange circumferentially around the reflective sheet 1. The through holes 12 each may have a diameter ranging from about 0.5 mm to about 2 mm, preferably 1 mm, and are spaced apart by a distance ranging from about 0.5 mm to about 2.0 mm, preferably 1.5 mm. The reflective sheet 1 in the present embodiment may have a thickness ranging from about 0.1 mm to about 2 mm, preferably 1 mm in the present embodiment. The optical characteristic of the reflecting surfaces 11a and 11b includes specular reflection and diffuse reflection, and the other portions of the reflecting surfaces may have any optical characteristics. In present embodiment, the reflective sheet 1 may vary in arrangement of the through holes, diameters of the through holes, spacing between the through holes and the thickness of the reflective sheet in accordance with specific applications.

FIG. 4 shows the design principle of the present embodiment. The plurality of LEDs 3 is circularly disposed on a plane EH. The flared annular reflecting surfaces 11a and 11b are oriented above the LEDs such that a first portion of the light emitting from the LEDs is reflected by the flared annular reflecting surface 11b to form a first radially outwardly diverging beam above the plane EH, a second portion of the light emitting from the LEDs is reflected from the flared annular reflecting surface 11a to form a second radially outwardly diverging beam below the plane EH, and a third portion of the light emitting from the LEDs passes through the through holes 12 and forms a forwardly-projecting beam.

The radially outwardly diverging beam reflected by the reflecting surface 11a is distributed uniformly in an illumination angle ranging from 0 to α below the horizontal plane EH, wherein α ranges from about 45° to about 75°, preferably 45°. That is, the marginal ray of the reflecting surface 11a includes an angle of θ=45° with the optical axis OZ. The radially outwardly diverging beam reflected by the reflecting surface 11b is distributed uniformly in an illumination angle ranging from 0 to β above the horizontal plane EH, wherein β ranges from about 30° to about 50°, preferably 30°. The optical characteristic of the reflecting surfaces 11a and 11b includes specular reflection and diffuse reflection, preferably specular reflection. The forwardly-projecting beam that is transmitted directly through the through holes 12 in the reflective sheet and projects forward along the original path has a field angle of Ψ, which ranges from about 90° to about 150°, preferably 90°. The size and density of the through holes 12 in the reflective sheet may be adjustable in order to make the light intensity distribution projecting forward, sideward and backward comparatively uniform.

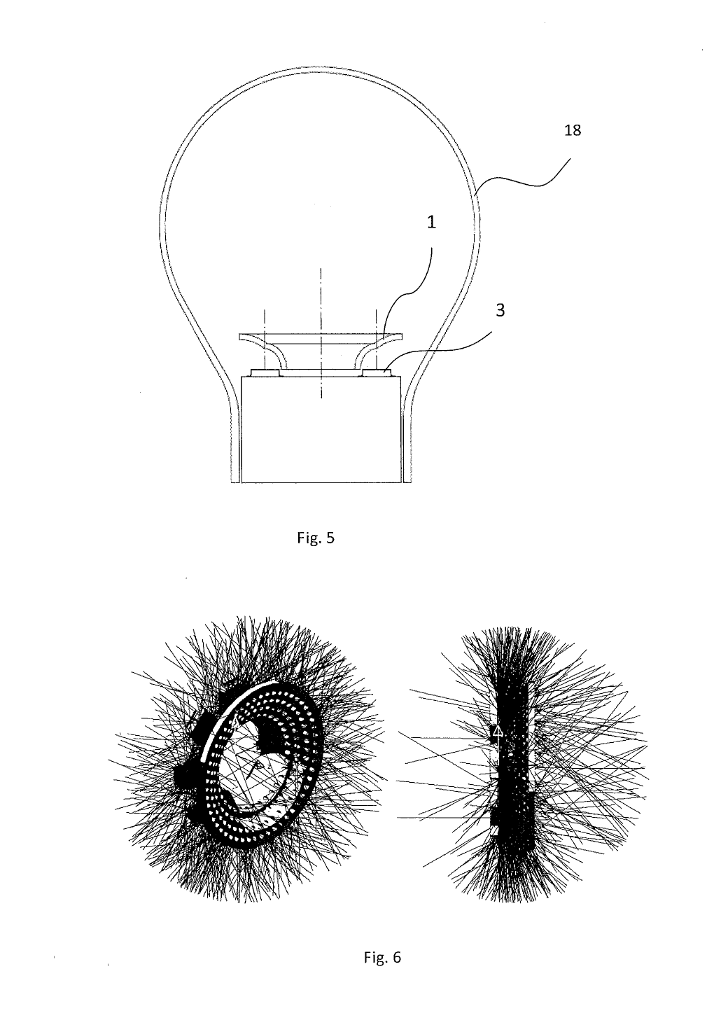

FIG. 5 shows the application of the Embodiment 1 in an LED bulb lamp, which adopts the secondary optical apparatus of the present embodiment. The bulb lamp may be in the form of a substantially spherical light-transmittable cover 18 such as a frosted or semitransparent milky white lampshade made of glasses or plastics, which may achieve a wide angular light distribution with a field angle of about 270° to about 360°. The emitting light may be full of almost all space therearound. This bulb lamp feature can be applied to other embodiments of the invention.

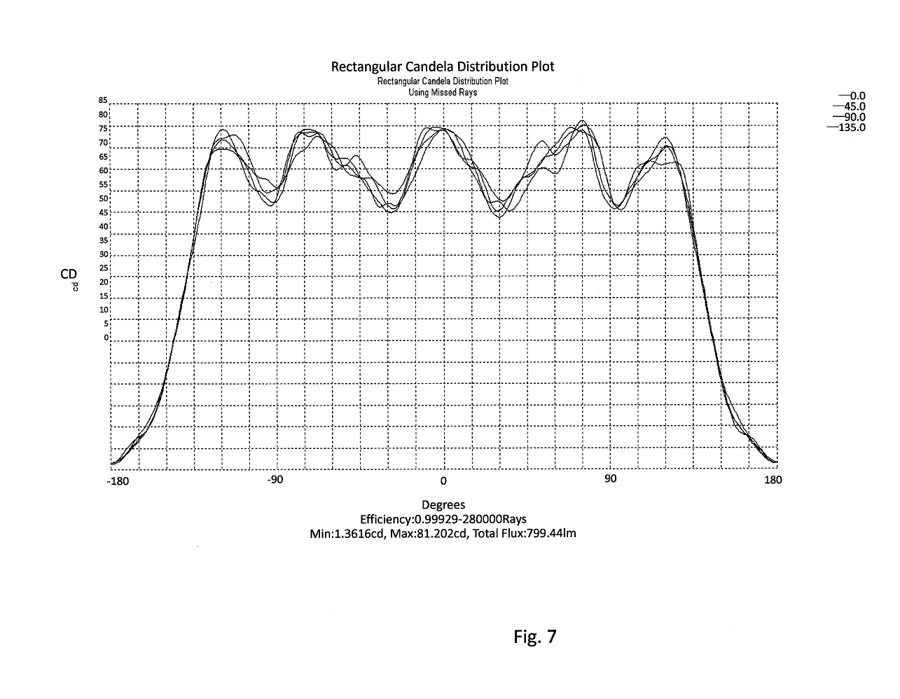

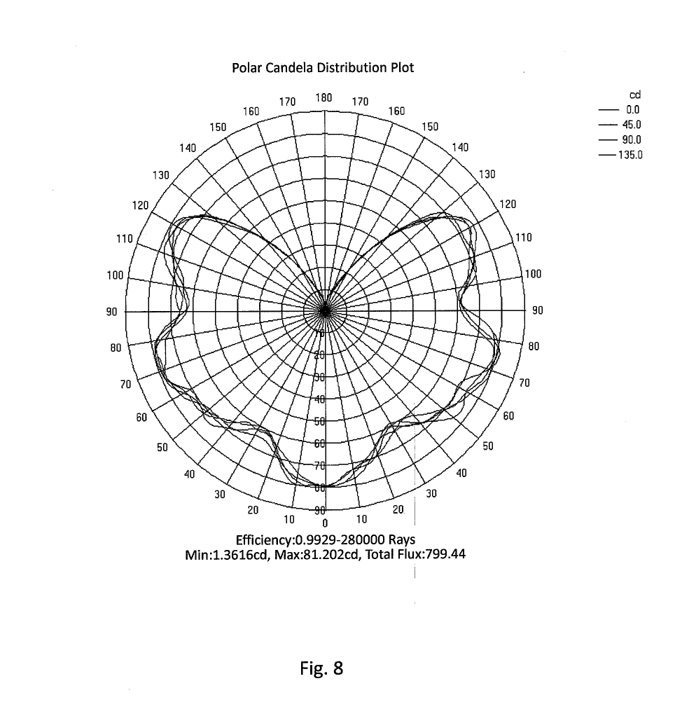

It shows the computer simulation graph hereafter, in which FIG. 6 shows the ray trace of the present embodiment, and FIG. 7 and FIG. 8 show the far-field angular distribution of the light intensity in Cartesian coordinates and polar coordinates. In these figures, it is seen that, with the present embodiment, the uniformity of the light intensity distribution may be up to about 70% in the range of 270° (±135°).

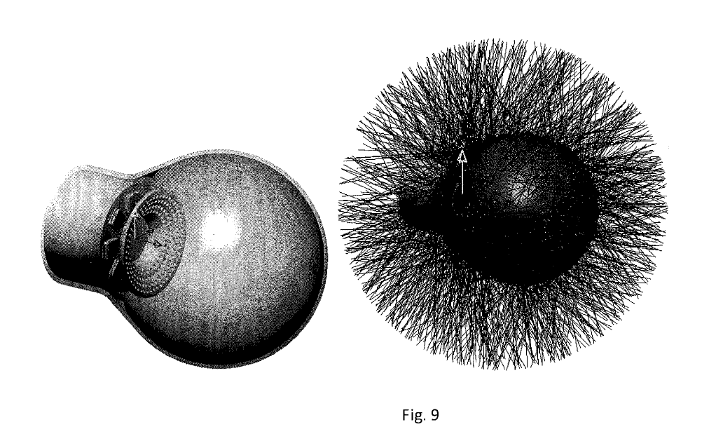

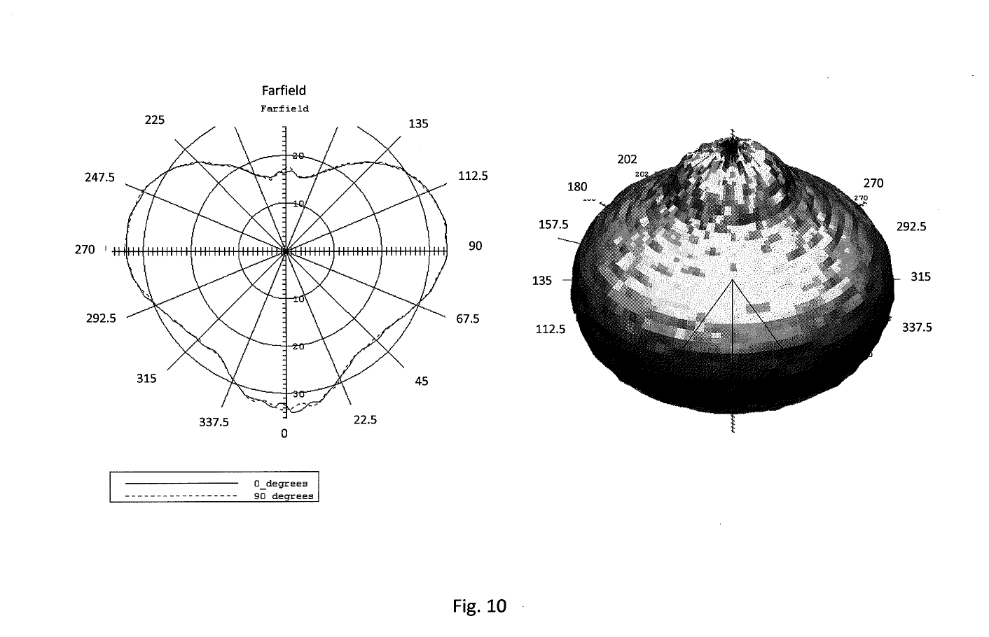

FIG. 9 is the ray trace of a LED bulb lamp equipped with a frosted lampshade adopting the Embodiment 1, wherein the lampshade in this figure assumes to be a frosted glass lampshade with a scattering ratio of 50%. FIG. 10 is the light distribution curve of the LED bulb lamp adopting the Embodiment 1, in which it can be seen that after addition of the frosted glass lampshade with the scattering ratio of 50%, the light distribution curve thereof becomes a smooth peach shape, which indicates the field angle of the light is 360°.

### Embodiment 2

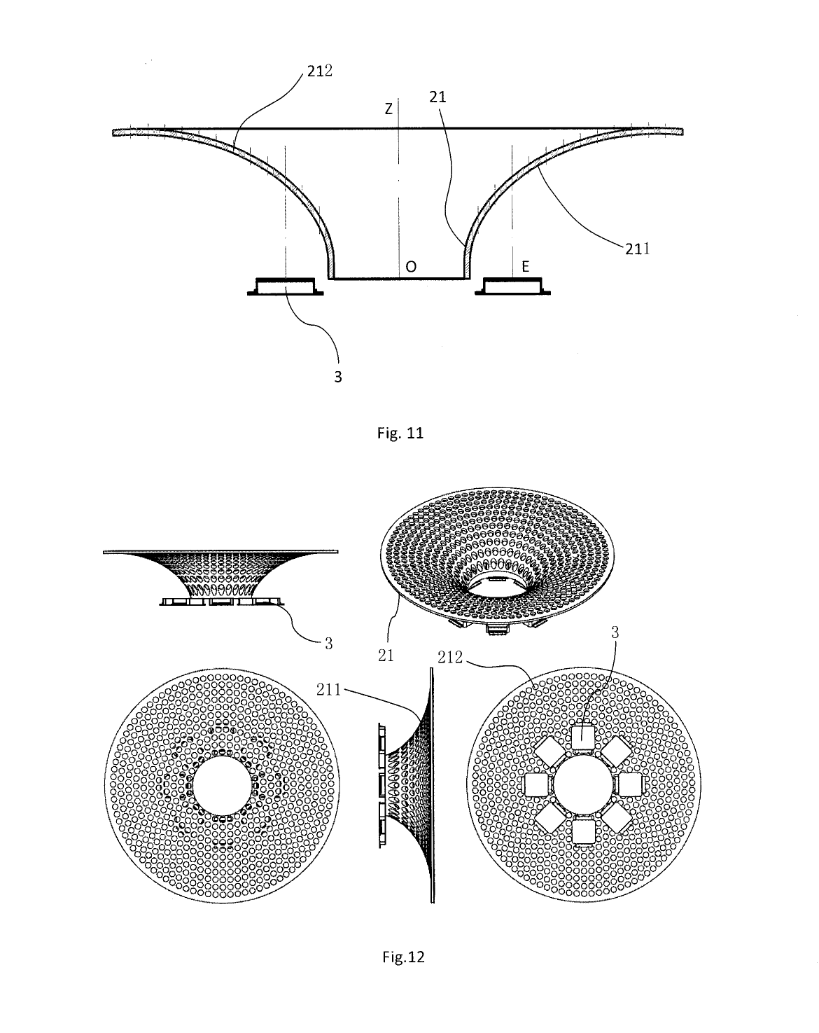

The solution that distributes the circular LED in an ultra large azimuth ranging in 270°˜360° may be described below. FIG. 11 is a section view of the Embodiment 2, which differs from the Embodiment 1 in that the reflector or reflective sheet 21 is a single continuous ring-shaped reflective sheet, the diameter-to-height ratio of which is greater than that of Embodiment 1. The operational surface of the reflective sheet is a single flared annular reflecting surface 211, which reflects the incident light from the LED sideward and backward, resulting a continuous light distribution sideward and backward, and the optical characteristic of which includes specular reflection and diffuse reflection. The reflective sheet includes many minute apertures or through holes 212, which allow the projection of a portion of the incident light from the LED forward along the original light path. The Embodiment 2 shares the substantially same light distribution computation with the Embodiment 1, except that the Embodiment 2 utilizes a continuous light distribution, in which the reflective sheet 21 is a single continuous ring-shaped reflective surface, which results in that the diameter-to-height ratio is greater than that of the Embodiment 1. However, it is less sensitive to errors in assembling position, dimensional errors, processing errors and errors in reflectivity.

FIG. 12 shows different views of the reflective sheet 21 of the present embodiment. The reflective sheet includes a circular continuous reflective sheet. The reflective sheet has many small through holes 212 therein, which have a shape of a circle or a polygon or any possible shape, preferably circular through holes. The through holes each may have a diameter ranging from about 0.5 mm to about 2 mm, preferably 1 mm, and spaced by a distance ranging from about 0.5 mm to about 2 mm, preferably, 1.5 mm.

The reflective sheet in present embodiment may have a thickness ranging from about 0.1 mm to about 2.0 mm, preferably 0.5 mm in present embodiment. The optical characteristic of the reflecting surface 211 includes specular reflection and diffuse reflection, preferably specular reflection, and the other portions of the reflecting surfaces may have any optical characteristics. The LEDs 3 may be a LED light source array arranged in a circle by four or more respective patch LEDs or semi-spherically packaged LEDs. In this case, the present invention preferably adopts 8 patch MX6 LEDs from CREE® which form a light source in a circle.

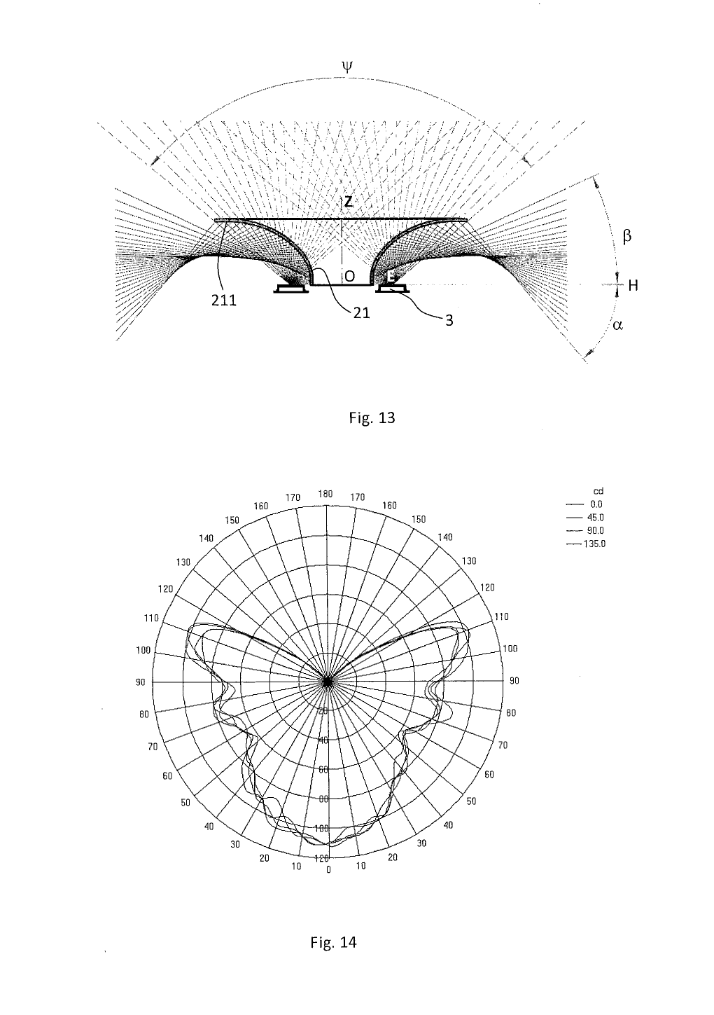

FIG. 13 shows the design principle of the present embodiment. The plurality of LEDs 3 is circularly disposed on a plane EH. The flared reflecting surface 21 is oriented above the LEDs such that a first portion of the light emitting from the LEDs is reflected by the flared reflecting surface 21 to form a radially outwardly diverging beam above and below the plane EH, and a second portion of the light emitting from the LEDs passes through the through holes and forms a forwardly-projecting beam.

The reflective sheet 21 uniformly distributes the light emitted from the LED light source array 3 in an illumination angle ranging from 0 to β over the horizontal plane EH, and from 0 to α below the horizontal plane EH, wherein β ranges from about 30° to about 50°, preferably 30°, and a ranges from about 45° to about 75°, preferably 45°. The optical characteristic of the reflecting surface 211 includes specular reflection and diffuse reflection, preferably specular reflection. The light that is transmitted directly through the through holes 212 in the reflective sheet and projects forward along the original path has a field angle of Ψ, which ranges from about 90° to about 150°, preferably 90°. The size and density of the through holes 212 in the reflective sheet may be adjustable in order to make the light intensity distribution projecting forward, sideward and backward comparatively uniform.

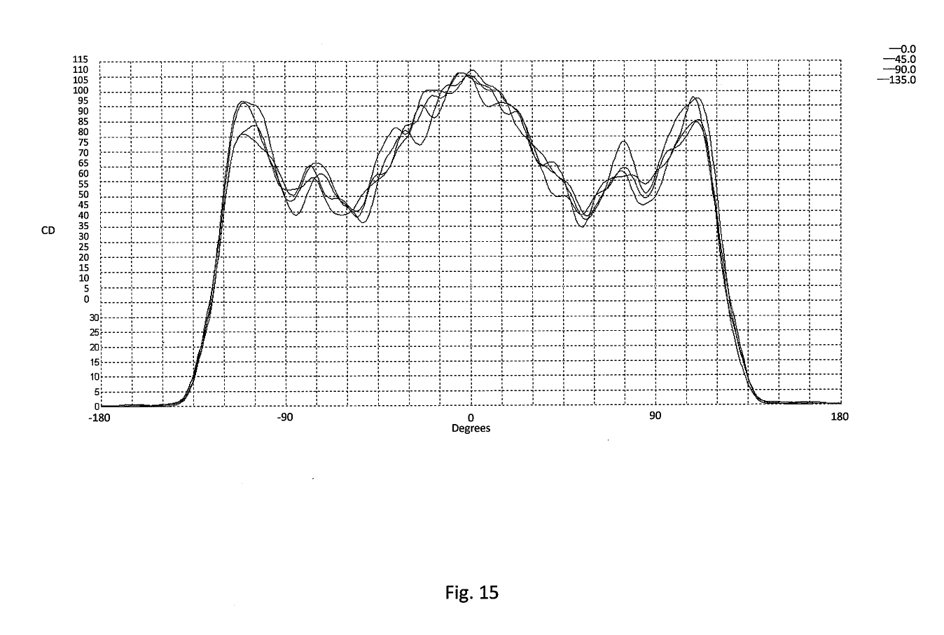

FIG. 14 and FIG. 15 show the computer simulation of the present embodiment, in which they show the far-field angular distribution of the light intensity in polar coordinates and Cartesian coordinates, respectively. In these figures, it is seen that, with the present embodiment, the uniformity of the light intensity distribution may be up to about 60% in the range of 270° (±135°), resulting the light distribution curve like a peach shape.

Although it has been shown and described that the reflective surface in Embodiments 1 and 2 is a continuous curved surface, it is understood by one skilled in the art that the reflecting surface may be in any other possible shape so long as it can reflect the light emitting from the LEDs sideward and backward. For example, the reflecting surface can be in the form of one or more truncated cones with flat cross section. Furthermore, the reflecting surface may be formed of a plurality of reflective pieces and the reflecting surface can be substantially annular.

### Embodiment 3

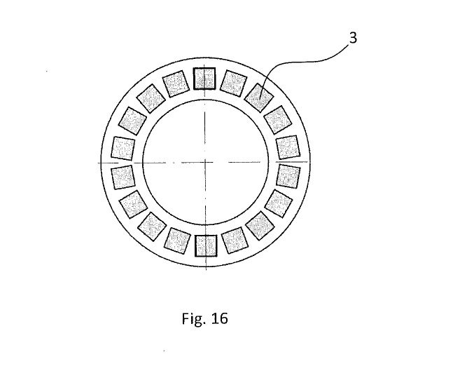

The present embodiment relates to a secondary optical apparatus of a circular LED array. The structure may feature a refractive-total reflection lens, in which the refractive portion thereof projects a portion of the light forward to form a light distribution ranging from about 90° to about 120°, and the total reflection portion thereof projects a portion of the light sideward to form a light distribution of about 90° and backward to form a light distribution ranging from about 270° to about 360°. FIG. 16 shows an arrangement of a circular LED light source according to Embodiment 3, in which a plurality of LED chips forms a circle and LED chips are applied with fluorescent powers and packaged. The size of the LED chips may be determined according to specific applications, preferably a size of 1×1 mm for the LED chip in the present embodiment.

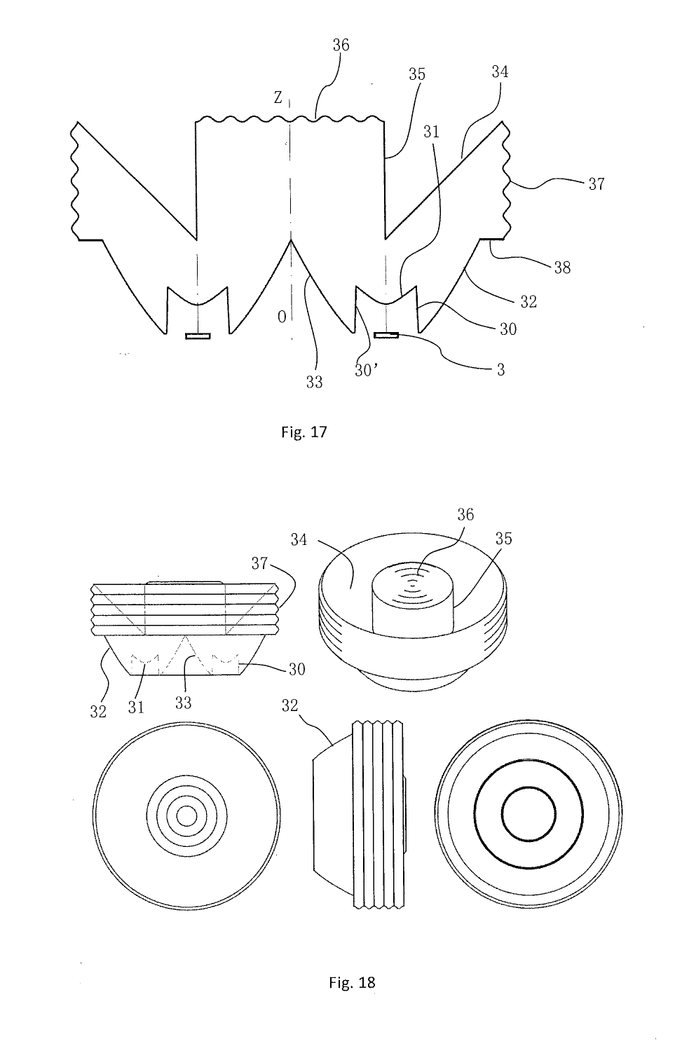

FIG. 17 shows a section view of a secondary optical apparatus adopting a refractive-total reflection lens according to the present embodiment. FIG. 18 shows different views of the secondary optical lens according to present embodiment. In these figures, the numeral reference 3 indicates the LED light source according to present embodiment. The lens has a lens body. An annular recess is formed on a bottom side of the lens body in which the LEDs are located. The annular recess is defined by a middle annular collimating surface 31 facing the LED light source, an outer annular side surface 30 and an inner annular side surface 30′.

The lens includes outer and inner annular total reflection surfaces 32, 33 (TIR-total internal reflection) outside and inside of the lens, respectively. The outer annular total reflection surface 32 is formed on a lower portion of the lens body and extends outwardly from the outer annular side surface 30. The inner annular total reflection surface 33 is formed on the lower portion of the lens body and extends inwardly from the inner annular side surface 30′.

A central solid cylindrical portion having a cylindrical surface 35 is formed at a top side of the lens body and has an upper light-diverging surface 36, the area of which takes up half of the full aperture of the lens. The upper light-diverging surface 36 may be in the shape of a plurality of concentric rings having a sinusoidal cross-section.

An inverted frusto-conical total reflection surface extends outwardly from the cylindrical surface of the central solid cylindrical portion 35. The cylindrical surface of the central solid cylindrical portion connects the upper light-diverging surface 36 and the inverted frusto-conical total reflection surface 34. An annular light-diverging surface 37 having a sinusoidal cross-section is formed between the inverted frusto-conical total reflection surface 34 and the outer annular total reflection surface 32.

The lens may further include a platform 38 connecting the annular light-diverging surface 37 and the outer annular total reflection surface 32 for positioning during assembly.

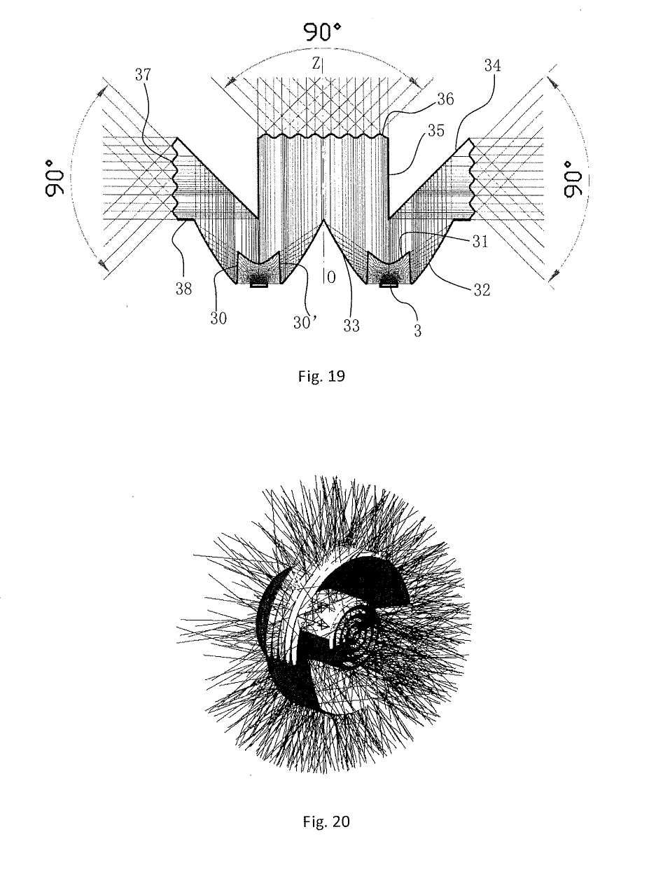

FIG. 19 shows the design principle of Embodiment 3. A first portion of the light emitting from the LEDs and passing through the outer annular side surface 30 is reflected upwards by the outer annular total reflection surface 32 and then reflected radially outwardly by the inverted frusto-conical total reflection surface 34 towards the annular light-diverging surface 37 to form a first radially outwardly diverging beam. A second portion of the light emitting from the LEDs and passing through the middle annular collimation surface 31 is collimated and reflected radially outwards by the inverted frusto-conical total reflection surface 34 towards the annular light-diverging surface 37 to form a second radially outwardly diverging beam. A third portion of the light emitting from the LEDs and passing through the middle annular collimation surface 31 is collimated towards the upper light-diverging surface 36 to form a first forwardly-projecting beam. A fourth portion of the light emitting from the LEDs and passing through the inner annular side surface 30′ is reflected by the inner annular total reflection surface 33 upwardly towards the upper light-diverging surface to form a second forwardly-projecting beam. The first and second radially outwardly diverging beams have an illumination angle of about 90°, and the first and second forwardly-projecting beams have an illumination angle of about 90°.

The light emitted from the circular LED light source and including an angle within ±40° with the optical axis OZ is collimated by the annular collimating surface 31. Thereafter, the collimated light is split into two portions, wherein the inner portion thereof emits through the upper light-diverging surface 36, which uniformly distributes the emitted light in an illumination angle of about 90°. The outside portion of the collimated light collimated by the annular collimating surface 31 is reflected sideward by the inverted frusto-conical total reflection surface 34 of the lens, and then distributed through the annular light-diverging surface 37, which uniformly distributes the emitted light sideward with an illumination angle of about 90°. The light emitted from the circular LED light source and including an angle within ±40°˜±90° with the optical axis OZ passes through the outer and inner annular side surfaces 30, 30′, and incidents into the outer annular total reflection surface 32 and the inner annular total reflection surface 33, which reflect the incident light in a direction parallel to the optical axis. A portion of the light reflected by the inner annular reflective surface 33 emits though the upper light-diverging surface 36, and is uniformly distributed with an illumination angle of about 90°. The other portion of light reflected by the outer annular reflective surface 32 is reflected sideward by the inverted frusto-conical total reflection surface 34, and is uniformly distributed sideward by the annular light-diverging surface 37 with an illumination angle of about 90°. The light distribution from the light-diverging surfaces 36 and 37 is superposed to form a light distribution in the range of about 270°.

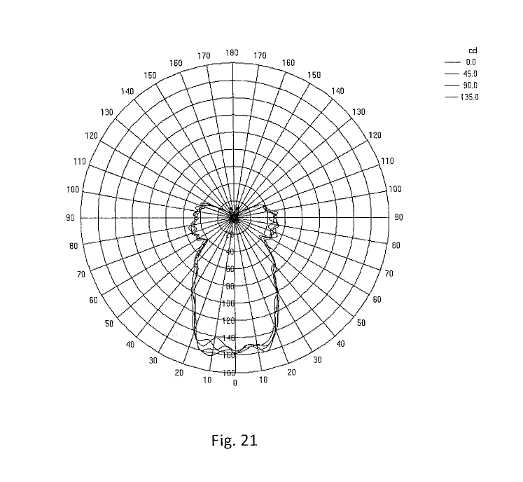

FIG. 20 shows the ray trace of the present embodiment. FIG. 21 shows the far-field angular distribution of the light intensity (light distribution curve) according to present embodiment, which exhibits a stronger forward light intensity compared with the Embodiments 1 and 2, with a bottle shaped light distribution curve, suitable to applications requiring more luminance under the lamp.

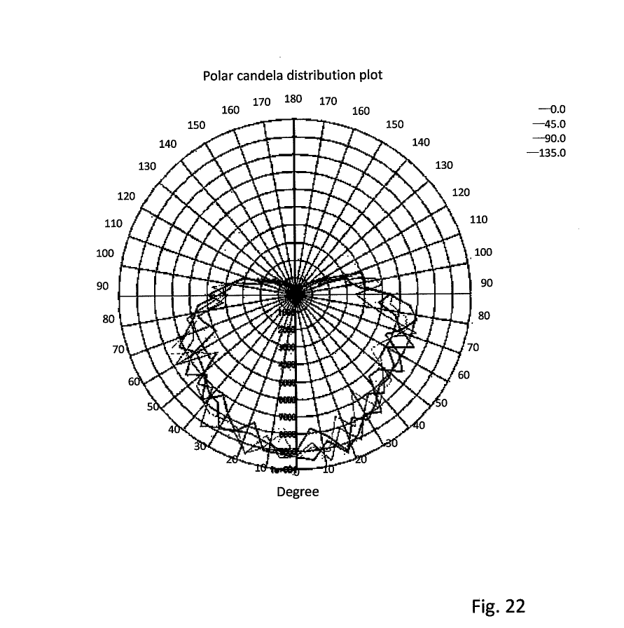

The Embodiment 3 may achieve a comparatively uniform light distribution of the far-field angle when the size of a single chip is small (for example, 0.2×0.2 mm), the density of the fluorescent powder is high, and applying area thereof is less, in which the light distribution curve shapes like a peach, as shown in FIG. 22.

The foregoing description of an implementation of the invention has been presented for purpose of illustration and description. It is not exclusive and does not limit the invention to the precise form disclosed. Modifications and variations are possible in light of the above teachings or may be acquired from practicing the invention.

1. A secondary optical apparatus for a circular light emitting diode array, the apparatus comprising:
(a) a plurality of light emitting diodes (LEDs) circularly disposed on a plane; and
(b) a reflector having an annular reflecting surface oriented above the LEDs such that one portion of the light emitting from the LEDs is reflected by the annular reflecting surface sideward and backward to form a radially outwardly diverging beam having light distribution above and below the plane, and another portion of the light emitting from the LEDs is directed forward to form a forwardly-projecting beam.

2. The secondary optical apparatus as claimed in claim 1, wherein the reflector comprises:
(a) a flared reflecting surface; and
(b) a plurality of apertures extending through and arranged circumferentially around the reflector;
(c) whereby a first portion of the light emitting from the LEDs is reflected by the flared reflecting surface to form the radially outwardly diverging beam, and a second portion of the light emitting from the LEDs passes through the apertures and forms the forwardly-projecting beam.

3. The secondary optical apparatus as claimed in claim 2, wherein the radially outwardly diverging beam has an illumination angle of about 30° to about 50° above the plane and an illumination angle of about 45° to about 75° below the plane, and the forwardly-projecting beam has a field angle of about 90° to about 150°.

4. The secondary optical apparatus as claimed in claim 1, wherein the reflector comprises:
(a) first and second flared reflecting surfaces; and
(b) a plurality of apertures extending through and arranged circumferentially around the reflector;
(c) whereby a first portion of the light emitting from the LEDs is reflected by the first flared reflecting surface to form a first radially outwardly diverging beam above the plane, a second portion of the light emitting from the LEDs is reflected from the second flared reflecting surface to form a second radially outwardly diverging beam below the plane, and a third portion of the light emitting from the LEDs passes through the apertures and forms the forwardly-projecting beam.

5. The secondary optical apparatus as claimed in claim 4, wherein the first radially outwardly diverging beam has an illumination angle of about 30° to about 50° above the plane, the second radially outwardly diverging beam has an illumination angle of about 45° to about 75° below the plane, and the forwardly-projecting beam has a field angle of about 90° to about 150°.

6. The secondary optical apparatus as claimed in claim 1, comprising at least four LEDs.

7. The secondary optical apparatus as claimed in claim 1, wherein the thickness of the reflector is about 0.1 mm to about 2.0 mm.

8. The secondary optical apparatus as claimed in claim 2, wherein each aperture is circular and has a diameter of about 0.5 mm to about 2.0 mm.

9. The secondary optical apparatus as claimed in claim 2, wherein the distance between two adjacent apertures is about 0.5 mm to about 2.0 mm.

10. The secondary optical apparatus as claimed in claim 1, wherein the reflector is in the form of a lens comprises:
(a) a lens body;
(b) an annular recess formed on a bottom side of the lens body in which the LEDs are located, the annular recess being defined by a middle annular collimation surface, an outer annular side surface and an inner annular side surface;
(c) an outer annular total reflection surface formed on a lower portion of the lens body and extending outwardly from the outer annular side surface, and an inner annular total reflection surface formed on the lower portion of the lens body and extending inwardly from the inner annular side surface;
(d) a central solid cylindrical portion formed at a top side of the lens body and having an upper light-diverging surface in the shape of a plurality of concentric rings having a sinusoidal cross-section;
(e) an inverted frusto-conical total reflection surface extending outwardly from a cylindrical surface of the central solid cylindrical portion; and
(f) an annular light-diverging surface having a sinusoidal cross-section formed between the inverted frusto-conical total reflection surface and the outer annular total reflection surface;
(g) whereby a first portion of the light emitting from the LEDs and passing through the outer annular side surface is reflected upwards by the outer annular total reflection surface and then reflected radially outwardly by the inverted frusto-conical total reflection surface towards the annular light-diverging surface to form a first radially outwardly diverging beam, a second portion of the light emitting from the LEDs and passing through the middle annular collimation surface is collimated and reflected radially outwards by the inverted frusto-conical total reflection surface towards the annular light-diverging surface to form a second radially outwardly diverging beam, a third portion of the light emitting from the LEDs and passing through the middle annular collimation surface is collimated towards the upper light-diverging surface to form a first forwardly-projecting beam, and a fourth portion of the light emitting from the LEDs and passing through the inner annular side surface is reflected by the inner annular total reflection surface upwardly towards the upper light-diverging surface to form a second forwardly-projecting beam.

11. The secondary optical apparatus device as claimed in claim 10, wherein the first and second radially outwardly diverging beams have an illumination angle of about 90°, and the first and second forwardly-projecting beams have an illumination angle of about 90°.

12. The secondary optical apparatus device as claimed in claim 10, further comprising an annular platform formed between the annular light-diverging surface and the outer annular total reflection surface.

13. The secondary optical apparatus as claimed in claim 2, further comprising a substantially spherical light-transmittable cover for covering the reflector and the LEDs, whereby the light emitting through the cover has a field angle of about 270° to about 360°.
